(19) United States
(12) Patent Application Publication
(10) Pub. No.: US 2018/0284371 A1
(43) Pub. Date: Oct. 4, 2018

(54) OPTICAL ELEMENT MODULE

(71) Applicant: Sumitomo Osaka Cement Co., Ltd, Tokyo (JP)

(72) Inventors: Toshio Kataoka, Tokyo (JP); Norikazu Miyazaki, Tokyo (JP); Kei Kato, Tokyo (JP)

(21) Appl. No.: 15/893,789

(22) Filed: Feb. 12, 2018

(30) Foreign Application Priority Data
Mar. 31, 2017 (JP) 2017-072934

(51) Int. Cl. G02B 6/42; G02B 6/30

(52) U.S. Cl. CPC G02B 6/4238; G02B 6/4248; G02B 6/30

(57) ABSTRACT

An optical element module includes a housing which houses an optical element, in which the optical element is optically coupled to an optical fiber introduced into the housing, the optical fiber is held by a fiber fixing part provided at the housing, the fiber fixing part includes, along a longitudinal direction thereof, a first tubular portion, a second tubular portion which is connected to a through-hole provided in the side wall of the housing and has an inner diameter substantially equal to an inner diameter of the through-hole and smaller than an inner diameter of the first tubular portion, and a tapered portion which continuously connects the first tubular portion and the second tubular portion, and the other end of a slit of the fiber fixing part reaches the tapered portion or the second tubular portion.

### CROSS-REFERENCE TO RELATED APPLICATIONS

This application claims the benefit of Japanese Patent Application No. 2017-072934 filed Mar. 31, 2017, the disclosure of which is herein incorporated by reference in its entirety.

### BACKGROUND OF THE INVENTION

### Field of the Invention

The present invention relates to an optical element module and in particular, to an optical element module in which an optical element is housed in a housing and an optical fiber introduced into the housing and the optical element are optically coupled to each other.

### Description of Related Art

In an optical communication field or an optical measurement field, an optical element module such as an optical modulator is frequently used. An optical element mainly having a light modulation function is used to be housed in a metallic housing. In the optical element module, a configuration is made such that an optical fiber is introduced through a through-hole provided in the side wall of the housing, the optical element inside the housing is optically coupled to the optical fiber, and the through-hole is sealed.

As a method of fixing the optical fiber, there is a method in which a fiber fixing member is disposed to penetrate the side surface of a housing, as disclosed in Japanese Laid-open Patent Publication No. 7-199003, Japanese Laid-open Patent Publication No. 2004-145253, and Japanese Laid-open Patent Publication No. 2009-128677, or a method in which a fiber fixing part is cut off together with a housing and formed by integral processing, as disclosed in Japanese Laid-open Patent Publication No. 2015-069130.

In particular, in the method in which the fiber fixing part is formed by being processed integrally with the housing, since the housing and the fiber fixing part are continuously formed, airtightness is high, and since the outer diameter of the fiber fixing part can also be configured to be small, it is also possible to easily transfer heat to a metal material such as solder which is used for sealing and fixing.

FIG. 1 is a sectional view schematically showing an optical element module described in Japanese Laid-open Patent Publication No. 2015-069130. An optical element provided with an optical waveguide is disposed in a housing. An optical fiber is introduced from the outside of the housing and optically coupled to the optical waveguide. The optical fiber is configured of a bare fiber portion which serves as a core wire of the optical fiber, a fiber coating which covers the periphery of the bare fiber portion, and a protection member which covers the fiber coating.

The fiber fixing part for fixing the optical fiber protrudes from the side wall of the housing to the outside, and a cavity into which the optical fiber is inserted is formed inside thereof. The cavity is provided with a through-hole penetrating the side wall of the housing, and a tapered portion formed inside of the fiber fixing part. If the optical fiber is inserted from the outside of the fiber fixing part, the portion of a fiber protection member or a fiber coating of the optical fiber cannot be advanced due to the tapered portion. However, only the bare fiber portion passes through the through-hole and reaches the optical element.

FIG. 2 is a schematic view showing a cross section in the vicinity of the joint between the through-hole provided in the side wall of the housing and the fiber fixing part. If the optical fiber is disposed at a predetermined position of the through-hole, solder is supplied from a slit provided in the fiber fixing part to the through-hole side while heating the vicinity of a base of the fiber fixing part (the side wall side of the housing) with heating means. The dissolved solder infiltrates into the through-hole, as shown by a shaded portion in FIG. 2, by a capillary phenomenon and hermetically seals the through-hole.

A metal layer is coated on the surface of the bare fiber portion at the soldered portion of the optical fiber. Further, after the sealing of the optical fiber is completed, the protection member of the optical fiber is separately fixed by a fiber fixing part auxiliary member at an entrance of the fiber fixing part.

At the time of the work of sealing the optical fiber, if excessive heat is applied to the housing, there is a concern that it may lead to product failure. Further, in a case of using low-melting-point solder, filling failure occurs depending on conditions and airtight failure of a product itself also occurs.

Specifically, for complete sealing, for example, in a case where excessive heating at 600° C. or more is performed, heat is transferred to the optical fiber covered with the metal layer, and thus resin which is used for the connection between the optical element such as an optical modulation element and the optical fiber deteriorates, and a problem such as occurrence of fixing deviation due to softening of the resin arises. On the other hand, in a case of insufficient heating at 400° C. or less, flux which is included in the solder entrains gas to generate air bubbles, and in particular, airtight failure occurs in the region of the side wall of the housing.

### SUMMARY OF THE INVENTION

An object of the present invention is to solve the problem as described above and provide an optical element module in which solder filling failure is suppressed and airtightness has high reliability.

In order to solve the above problem, an optical element module according to the present invention has the following technical features.

(1) An optical element module includes: a housing which houses an optical element, in which the optical element is optically coupled to an optical fiber introduced into the housing through a through-hole provided in a side wall of the housing, in the outside of the housing, a protection member which protects the optical fiber led out from the through-hole is disposed at a part of the optical fiber and the optical fiber is held by a fiber fixing part provided at the housing through the protection member, the fiber fixing part includes, along a longitudinal direction of the fiber fixing part, a first tubular portion having an inner diameter larger than an outer diameter of the protection member, a second tubular portion which is connected to the through-hole provided in the side wall of the housing and has an inner diameter substantially equal to an inner diameter of the through-hole and smaller than the inner diameter of the first tubular portion, and a tapered portion which continuously connects the first tubular portion and the second tubular portion, the fiber fixing part further includes a slit which is formed along the longitudinal direction of the fiber fixing part and has a shape in which one end of the slit is open, the other end of the slit reaching the tapered portion or the second tubular portion, and in the inside of the second tubular portion, a gap between a bare fiber portion formed removing a coating of the optical fiber and an inner wall of the second tubular portion is sealed with a metallic material, so that the bare fiber portion and the inner wall of the second tubular portion are fixed to each other.

(2) In the optical element module according to the above (1), a taper angle of the tapered portion is set to be in a range of 60° to 130°.

(3) In the optical element module according to the above (1) or (2), a length L of the second tubular portion from the side wall of the housing to the tapered portion is set so as to satisfy a relationship of L≥D with respect to an inner diameter D of the second tubular portion.

(4) In the optical element module according to any one of the above (1) to (3), the housing and the fiber fixing part are integrally formed.

According to the present invention, the fiber fixing part includes, along the longitudinal direction of the fiber fixing part, the first tubular portion having an inner diameter larger than the outer diameter of the protection member of the optical fiber, the second tubular portion which is connected to the through-hole provided in the side wall of the housing and has an inner diameter substantially equal to the inner diameter of the through-hole and smaller than the inner diameter of the first tubular portion, and the tapered portion which continuously connects the first tubular portion and the second tubular portion, the fiber fixing part further includes the slit which is formed along the longitudinal direction of the fiber fixing part and has a shape in which one end of the slit is open, and the other end of the slit reaches the tapered portion or the second tubular portion. Therefore, it is possible to expose the vicinity of an entrance of the second tubular portion through the slit, it is possible to reliably supply solder, which is a metal material for sealing, to the second tubular portion, and it is possible to visually recognize the state of the solder in the vicinity of the entrance of the second tubular portion through the slit. In this way, it becomes possible to provide an optical element module in which solder filling failure is suppressed and airtightness has high reliability.

### BRIEF DESCRIPTION OF THE DRAWINGS

FIG. 1 is a sectional view showing a part of an optical element module.

FIG. 2 is a sectional view for explaining a structure of a fiber fixing part in the related art.

FIG. 3 is a sectional view for explaining an example of a structure of a fiber fixing part which is used in an optical element module according to the present invention.

FIG. 4 is a sectional view for explaining another example of the structure of the fiber fixing part which is used in the optical element module according to the present invention.

### DETAILED DESCRIPTION OF THE INVENTION

Hereinafter, the present invention will be described in detail using preferred examples.

An optical element module according to the present invention includes a housing which houses an optical element, in which the optical element is optically coupled to an optical fiber introduced into the housing through a through-hole provided in a side wall of the housing, in the outside of the housing, a protection member which protects the optical fiber led out from the through-hole is disposed at a part of the optical fiber and the optical fiber is held by a fiber fixing part provided at the housing through the protection member outside the housing, the fiber fixing part includes, along a longitudinal direction of the fiber fixing part, a first tubular portion (R3) having an inner diameter larger than an outer diameter of the protection member, a second tubular portion (R1) which is connected to the through-hole provided in the side wall of the housing and has an inner diameter substantially equal to an inner diameter of the through-hole and smaller than the inner diameter of the first tubular portion, and a tapered portion (R2) which continuously connects the first tubular portion and the second tubular portion, the fiber fixing part further includes a slit which is formed along the longitudinal direction of the fiber fixing part and has a shape in which one end of the slit is open, the other end (A) of the slit reaching the tapered portion (R2) or the second tubular portion (R1), and in the inside of the second tubular portion, a gap between a bare fiber portion formed by removing a coating of the optical fiber and an inner wall of the second tubular portion is sealed with a metallic material, so that the bare fiber portion and the inner wall of the second tubular portion are fixed to each other.

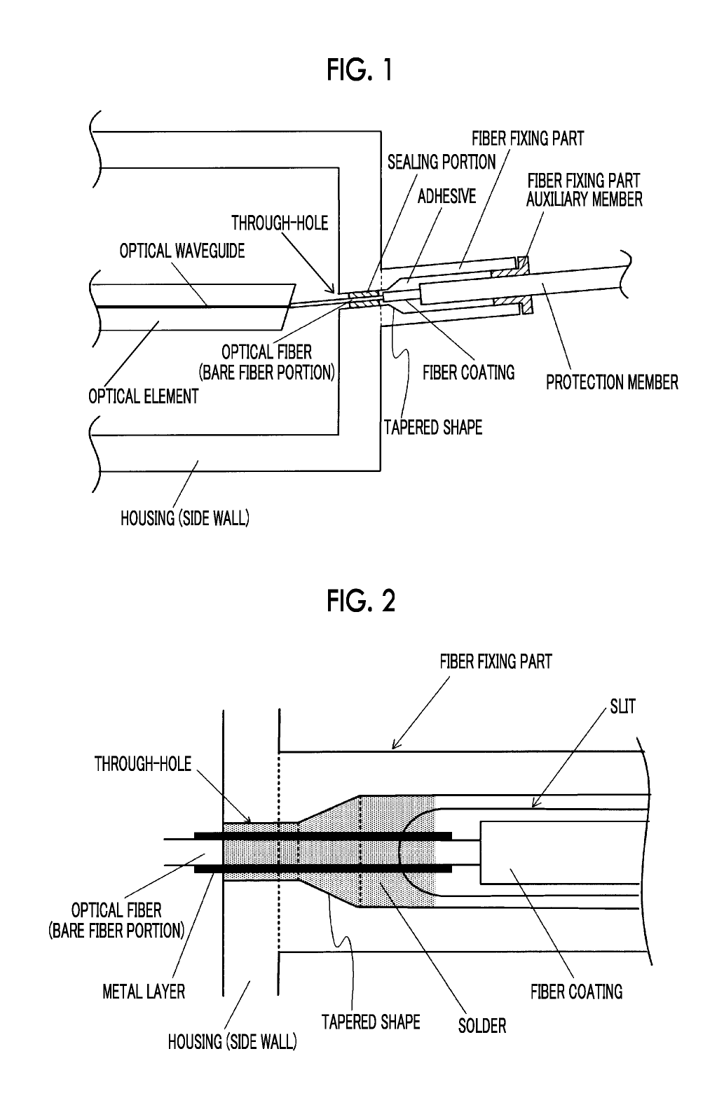

The overall configuration of the optical element module according to the present invention is substantially the same as that of the optical element module described with reference to FIG. 1, and therefore, description thereof is omitted here. In the following, description will be made to focus on an example in which the housing and the fiber fixing part are integrally processed. However, it goes without saying that the configuration of the fiber fixing part which includes the through-hole according to the present invention can be adopted in the fixing pipe as described in Japanese Laid-open Patent Publication No. 7-199003, Japanese Laid-open Patent Publication No. 2004-145253, and Japanese Laid-open Patent Publication No. 2009-128677. Further, in the formation with integral processing, although the processing cost increases, the airtightness of the housing can be increased and the manufacturing process can also be partially simplified.

The “bare fiber portion” in the present invention means an optical fiber composed of only a core and a cladding and is distinguished from an “optical fiber element wire” obtained by applying a thin protective film (primary coating) such as a UV coating to the bare fiber portion, and an “optical fiber core wire” which uses a resin protective film such as nylon for a coating layer (secondary coating) covering the optical fiber. With respect to the coated state of the optical fiber other than a sealing portion of the housing, there may be a coating as long as it does not greatly affect metallization treatment or sealing treatment. However, with respect to the coated state of the optical fiber in the portion which is inserted into the housing, it is preferable from the viewpoint of work efficiency that at least the secondary coating is removed, although it depends on the size of the through-hole in the side wall of the housing. Further, in order to secure the adhesiveness between the optical fiber and the solder, the surface of the bare fiber portion which is disposed in the through-hole is coated (covered) with a metal layer.

Further, the “coating of the optical fiber (fiber coating)” in the present invention means mainly the above-mentioned “primary coating”. Further, the above-mentioned “secondary coating”, a “loose tube”, or the like corresponds to the “protection member” in the present invention.

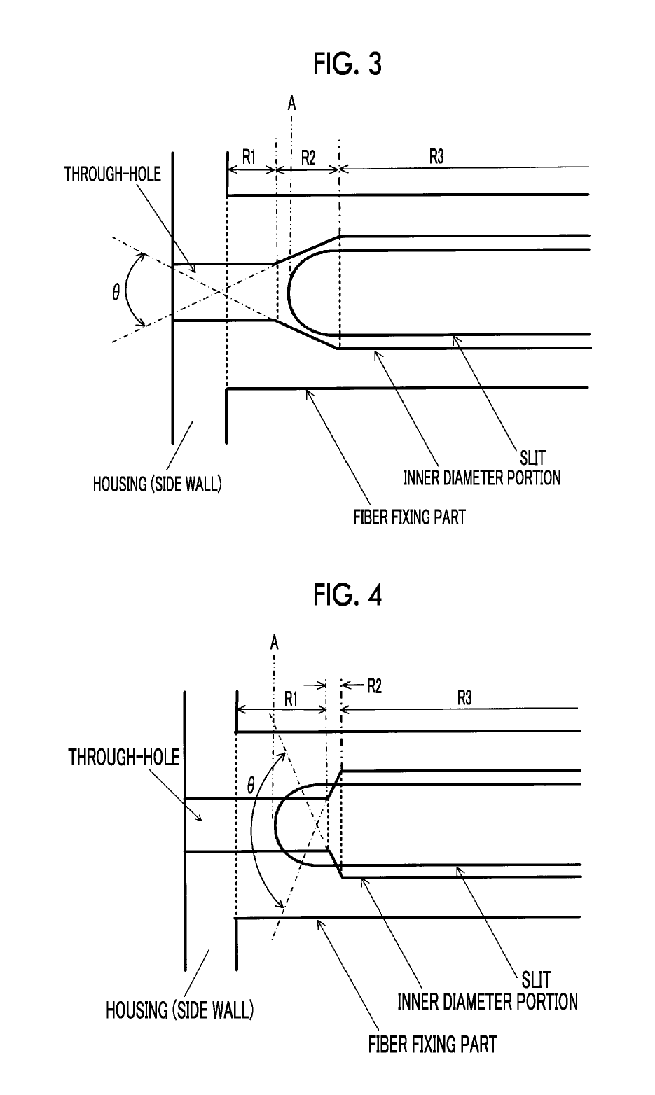

FIG. 3 is a sectional view for explaining an example of the structure of the fiber fixing part which is used in the optical element module according to the present invention. As shown in FIG. 3, the fiber fixing part protrudes from the side wall of the housing. The cross section perpendicular to a direction in which the optical fiber is inserted, of the fiber fixing part, usually has a circular outer shape, and the shape of the internal cavity is also a circular shape. Other shapes are also possible. However, in a case where the fiber fixing part is manufactured by cutting out, the manufacturing is more easily performed in the case of the circular cross section.

The inside of the fiber fixing part is composed of three portions along the longitudinal direction of the fiber fixing part (the left-right direction in FIG. 3). The inside of the fiber fixing part is composed of, from the right side, a first tubular portion (R3) having an inner diameter larger than an outer diameter of the protection member which covers the optical fiber, a tapered portion (R2) which continuously connects the first tubular portion and a second tubular portion (described later), and the second tubular portion (R1) which is connected to the through-hole provided in the side wall of the housing and has an inner diameter substantially equal to an inner diameter of the through-hole and smaller than the inner diameter of the first tubular portion are provided.

Here, the expression “an inner diameter substantially equal” means that in a case where the housing and the fiber fixing part are integrally processed, in many cases, the inner diameters become equal to each other, but a case where the inner diameter of the through-hole is wider than the inner diameter of the second tubular portion (R1) can also be allowed. In these cases, when the optical fiber is inserted from the right side of FIG. 3, the leading end thereof is not caught in the connection portion between the through-hole and the second tubular portion, and thus the assembling work can be performed smoothly.

It is preferable that a taper angle θ of the tapered portion (R2) which connects the first tubular portion (R3) and the second tubular portion (R1) is set to be in a range of 60° to 130°. The taper angle is set in this angle range, whereby it is possible to prevent the leading end of the optical fiber from being caught in the tapered portion at the time of the insertion of the optical fiber.

Further, in order to set the taper angle to be less than 60°, a special tool is required at the time of processing. For example, it is necessary to make a tip angle of a milling tool such as an end mill an acute angle. However, in this case, damage to a blade of a tip portion occurs frequently, high-accuracy cutting is difficult, and furthermore, the processed surface of the tapered portion becomes rough. On the other hand, if the taper angle is set to be larger than 130°, the effect of solder wettability (surface tension) is weakened, and therefore, the solder filling efficiency tends to be poor.

Next, in order to improve the thermal uniformity of the fiber fixing part (particularly, the portions R1 and R2), it is preferable that a length L of the second tubular portion (R1) is set so as to satisfy a relationship of L≥D with respect to an inner diameter D of the second tubular portion. At the time of melting of the solder, a soldering iron is disposed in the vicinity of the base of the fiber fixing part (on the side wall side of the housing). In a case where the length L of the second tubular portion (R1) is shorter than the inner diameter D, the heat of the soldering iron easily escapes to the side wall of the housing, and thus it becomes difficult to uniformly heat the entire second tubular portion.

Further, in a case where the inner diameter of the second tubular portion (R1) is made smaller than the inner diameter of the first tubular portion (R3), it is possible to make the wall thickness of the second tubular portion (R1) thick, and thus even in a case where the soldering iron is disposed at the first tubular portion (R3) and performs heating, heat is easily transferred to the second tubular portion (R1), so that it becomes possible to uniformly heat the second tubular portion.

Further, the fiber fixing part is provided with a slit which is formed along the longitudinal direction of the fiber fixing part and has a shape in which one end of the slit is open. It is preferable that the width of the slit is set in a range larger than the inner diameter of the second tubular portion (R1) and smaller than the inner diameter of the first tubular portion (R3). This is for exposing the vicinity of the entrance of the first tubular portion as much as possible and not lowering the mechanical strength of the fiber fixing part.

A main feature of the present invention is that the other end (A) of the slit reaches the tapered portion (R2), as shown in FIG. 3, or reaches the second tubular portion (R1), as shown in FIG. 4. In this way, it is possible to expose the vicinity of the entrance of the second tubular portion (R1) through the slit. The slit can be formed by pressing a blade of a grinder against the fiber fixing part from a direction perpendicular to the drawing and moving it in the left-right direction in the drawing. At this time, due to the rotation of the blade of the grinder, the shape of an end portion of the slit becomes semicircular. In a case of using a blade having a diameter smaller than the width of the slit, the shape of the end portion of the slit is not limited to the semicircle.

With the configuration described above, it is possible to supply the solder to the vicinity of the second tubular portion or directly to the second tubular portion. Moreover, it is also possible to visually recognize the state of the solder in the vicinity of the entrance of the second tubular portion through the slit, and therefore, workability is also good and it is also possible to suppress occurrence of solder filling failure.

Further, by extending the other end (A) of the slit to the second tubular portion (R1) or the tapered portion (R2), it is possible to place the solder closer to the through-hole of the side wall of the housing, which is a sealing portion. In this way, the sealing portion is filled with the solder by the wettability (surface tension) of the solder and a gold-plated fiber or a capillary phenomenon to the through-hole, and therefore, it is more preferable to place the solder on at least the tapered portion (R2).

A metal material such as solder supplied from the second tubular portion dissolves and infiltrates into the second tubular portion (R1) or the through-hole provided in the side wall of the housing, by a capillary phenomenon. In the inside of the second tubular portion or the like, a gap between the bare fiber portion formed by removing the coating of the optical fiber and the inner wall of the second tubular portion or the like is sealed with the metal material such as solder, so that the bare fiber portion and the inner wall of the second tubular portion or the like are fixed to each other.

In the sealed and fixed range, the fiber coating is removed, and thus in order to maintain the sealing property, a metal film (a metal layer), for example, Au or the like is formed on a glass portion of the optical fiber by vapor deposition or plating through base metal such as Cr (metallization treatment). Further, in addition to the metal film, pre-soldering may be performed with special metal solder or the like for glass. With respect to the coated state of the optical fiber other than the sealing portion of the housing, there may be a coating as long as it does not greatly affect the metallization treatment or the sealing treatment. However, with respect to the coated state of the optical fiber in the portion which is inserted into the housing, it is preferable from the viewpoint of work efficiency that at least the secondary coating is removed, although it depends on the size of the through-hole in the side wall of the housing.

In the configuration of the metalized bare fiber, for example, in a case where the wire diameter of the fiber is 0.125 mm, the metal coating has a plating film thickness in a range of about 0.1 to 0.5 In the plating film thickness of less than 0.1 μm, plating is easily peeled off due to insufficient mechanical strength. Further, for the plating, as an example, electroless nickel (Ni) is plated on a base, and thereafter, plating of each of electrolytic Ni, electroless Au, and electrolytic Au is performed. By thickening the film thickness of electroless Au or electrolytic Au, an oxide film becomes difficult to be formed due to nickel of the base. If an oxide film is formed on a metal coating, wettability deteriorates, and thus solder filling ability deteriorates.

A gap between the housing (the inner wall of the through-hole) plated with metal such as Au and the optical fiber is hermetically sealed by injecting solder paste or the like from the slit provided in the fiber fixing part, and performing local heating by bringing the soldering iron or the like into contact with the second tubular portion (R1) or the tapered portion of the fiber fixing part, or melting the solder paste or the like with induction heating means or the like. In the present invention, since a metal material such as solder can be directly supplied from the vicinity of the position where the sealing is formed, it is not necessary to overheat a wide range of the fiber fixing part, and since the soldering iron and the solder supply position are close to each other, it is also not necessary to provide a recessed portion (a recessed portion formed at the position close to the wall surface of the housing, of the fiber fixing part) as shown in Japanese Laid-open Patent Publication No. 2004-145253 or Japanese Laid-open Patent Publication No. 2015-069130. For this reason, it is possible to reduce thermal damage to the optical element or the optical fiber and it also becomes possible to maintain high mechanical strength of the fiber fixing part.

In the case of a single mode fiber, the diameter of the bare fiber portion formed by removing the fiber coating is about 0.125 mm, and therefore, by setting the inner diameter of the through-hole to be in a range of about 0.2 mm to 0.9 mm, it is possible to uniformly and efficiently solder the inside of the side wall of the housing with a capillary phenomenon at the time of melting of the solder.

Further, the outer diameter of the fiber fixing part is set to be in a range of about 2 to 3 mm.

In order to evaluate the thermal uniformity of the fiber fixing part, a temperature distribution due to a change in the internal shape of the fiber fixing part was examined by simulation.

As a prerequisite for the simulation, the outer diameter of the fiber fixing part was set to be 2.5 mm, the inner diameter of the first tubular portion was set to be 1.5 mm, and the inner diameter D of the second tubular portion (the through-hole) was set to be 0.8 mm.

As test bodies, test bodies were prepared in which the length L of the second tubular portion is 0.5 times the inner diameter D (a comparative example), the length L of the second tubular portion is 1 time the inner diameter D (Test Body 1), and the length L of the second tubular portion is 1.5 times the inner diameter D (Test Body 2).

Further, in order to reproduce a state where the soldering iron is brought into contact with the fiber fixing part at the time of heating, a case where constant temperature heating means having a temperature of 400° C. was brought into contact with the fiber fixing part in a range of 1 mm to 3 mm from the side wall of the housing was assumed.

Further, a temperature distribution after 1 second from the contact was simulated, and the results of a temperature at the center position of each of (a) the side wall of the housing, (b) the second tubular portion, and (c) the tapered portion, and (d) a temperature at the position 3 mm away from the side wall of the housing, of the first tubular portion, were compared.

From the result of the simulation, in (a) the side wall of the housing and (d) the first tubular portion, there was no significant difference between Test Bodies 1 and 2 and the comparative example. However, with respect to (b) the second tubular portion and (c) the tapered portion, in Test Bodies 1 and 2, a temperature rise in a range of about 10% to 20% with respect to the comparative example was observed, and thus it was confirmed that the second tubular portion or the tapered portion requiring solder sealing was efficiently heated.

As described above, according to the optical element module according to the present invention, it becomes possible to provide an optical element module in which solder filling failure is suppressed and airtightness has high reliability.

What is claimed is:

1. An optical element module comprising:
a housing which houses an optical element,
wherein the optical element is optically coupled to an optical fiber introduced into the housing through a through-hole provided in a side wall of the housing,
in the outside of the housing, a protection member which protects the optical fiber led out from the through-hole is disposed at a part of the optical fiber and the optical fiber is held by a fiber fixing part provided at the housing through the protection member,
wherein the fiber fixing part includes, along a longitudinal direction of the fiber fixing part, a first tubular portion having an inner diameter larger than an outer diameter of the protection member, a second tubular portion which is connected to the through-hole provided in the side wall of the housing and has an inner diameter substantially equal to an inner diameter of the through-hole and smaller than the inner diameter of the first tubular portion, and a tapered portion which continuously connects the first tubular portion and the second tubular portion,
the fiber fixing part further includes a slit which is formed along the longitudinal direction of the fiber fixing part and has a shape in which one end of the slit is open, the other end of the slit reaching the tapered portion or the second tubular portion, and
in the inside of the second tubular portion, a gap between a bare fiber portion formed by removing a coating of the optical fiber and an inner wall of the second tubular portion is sealed with a metallic material, so that the bare fiber portion and the inner wall of the second tubular portion are fixed to each other.

2. The optical element module according to claim 1, wherein a taper angle of the tapered portion is set to be in a range of 60° to 130°.

3. The optical element module according to claim 1, wherein a length L of the second tubular portion from the side wall of the housing to the tapered portion is set so as to satisfy a relationship of L≥D with respect to an inner diameter D of the second tubular portion.

4. The optical element module according to claim 1, wherein the housing and the fiber fixing part are integrally formed.
